(19) United States
(12) Patent Application Publication
(10) Pub. No.: US 2013/0293716 A1
(43) Pub. Date: Nov. 7, 2013

(54) MOBILE MAPPING SYSTEM FOR ROAD INVENTORY

(71) Applicant: Intelligent Technologies International, Inc., Boonton, NJ (US)

(72) Inventor: David S. Breed, Miami Beach, FL (US)

(73) Assignee: INTELLIGENT TECHNOLOGIES INTERNATIONAL, INC., Boonton, NJ (US)

(21) Appl. No.: 13/937,347

(22) Filed: Jul. 9, 2013

Related U.S. Application Data
(63) Continuation of application No. PCT/US2012/020958, filed on Jan. 11, 2012.
(60) Provisional application No. 61/431,478, filed on Jan. 11, 2011.

(51) Int. Cl. H04N 7/18

(52) U.S. Cl. CPC H04N 7/181
USPC 348/148

(57) ABSTRACT

Vehicle for obtaining data for road mapping including a first camera system mounted on the vehicle and positioned to obtain images in a substantially vertical plane of at least part of the road lane and adjacent area, a second camera system mounted on the vehicle adjacent the first camera system and positioned to obtain images in a substantially vertical plane of substantially the same portion of the road lane and adjacent area as the first camera system, a source of structured light emanating from a location apart from the second camera system but illuminating the ground in the field of view of the second camera system and at least one GNSS module containing a GPS receiver and an inertial navigation system.

### CROSS REFERENCE TO RELATED APPLICATION

This application is a continuation of International Application No. PCT/US2012/020958, filed Jan. 11, 2012, which claims priority of U.S. provisional patent application Ser. No. 61/431,478 filed Jan. 11, 2012, both of which are incorporated by reference herein.

### FIELD OF THE INVENTION

The present invention relates generally to methods and arrangements for creating a map database for a vehicle, in particular, a centimeter-accurate map database for a vehicle, and is more specifically related to mapping vehicle arrangements for acquiring data needed for such map databases and maps generated thereby or therefrom.

### BACKGROUND OF THE INVENTION

A detailed discussion of background information is set forth in commonly owned patent applications and patents including, for example, patent applications that issued as U.S. Pat. Nos. 6,405,132, 6,526,352, 6,768,944, 7,085,637, 7,110,880, 7,202,776, 7,610,146, 7,647,180 and 7,840,355, and in U.S. provisional patent application Ser. No. 61/226,932, all of which are incorporated by reference herein. Also incorporated by reference herein are the U.S. patent applications that published as US 20080162036, US 20090140887, and US 20090030605.

All of the patents, patent applications, technical papers and other references mentioned herein and in the related applications are incorporated by reference herein in their entirety. No admission is made that any or all of these references are prior art and indeed, it is contemplated that they may not be available as prior art when interpreting 35 U.S.C. §102 in consideration of the claims of the present application.

Definitions of terms and abbreviations used in the specification and claims are also found in the related patents and applications listed above.

The overall structure of the system incorporating this invention is a combination of components for collection, processing and utilization of road spatial data. This GIS system includes four basic components:
1. Data Acquisition System which is the MMS (Mobile Mapping System) or the Mapping Vehicle
2. Data Processing System
3. Spatial Object Oriented Data Base of the Road Infrastructure
4. System for accessing the Road Data

This invention disclosure is concerned with the first of these components.

The prior art consists primarily of the On-Sight® MMS (Mobile Mapping System) which was initiated by the Center for Mapping at Ohio State University and the University of Calgary, Canada. The original principle is based on georeferencing of a photogrammetric model by integrating it with data obtained from GPS, INS and an odometer. The more recently developed On-Sight® system consists of three basic modules:
Image acquisition module;
Positioning and attitude acquisition module; and
Data storing and time tagging module.

The disclosure herein is primarily concerned with a new image acquisition module as a substitute for the On-Sight® system image acquisition module.

### OBJECTS AND SUMMARY OF THE INVENTION

An exemplifying, non-limiting object of at least one embodiment of the present invention is to provide methods and arrangements for acquiring image data used in the process of creating a centimeter-accurate map database for use, for example, on vehicles.

In order to achieve this object and possibly others, a mapping vehicle is disclosed which can comprise two linear cameras each mounted on a top, to a side of and/or in front of the vehicle, each of which preferably has a field of view lying in a plane substantially perpendicular to a road on which the vehicle travels and which field of view includes the road at approximately the vehicle center line and outwardly to a location substantially beyond the edge of the lane on which the vehicle is traveling. A second pair of cameras is optionally provided, which cameras are substantially parallel and adjacent to each of the above-mentioned cameras and viewing substantially the same view as the primary cameras but slightly displaced in front of or behind the primary cameras. Each primary camera also has an associated illumination source which can be in the visual part of the spectrum and which is preferably designed to project illumination substantially onto a line to illuminate the field of view of each of or the associated one of the primary cameras. Each secondary camera can also have an associated illumination source that can be, for example, in the form of a linear array of dots which illuminates the field of view of each secondary camera. These dots can be, for example, in the infrared (IR) portion of the electromagnetic spectrum and, preferably, in the eye-safe portion of this spectrum. The secondary cameras can be designed to be sensitive to IR radiation and optionally comprise filters that remove radiation from other portions of the spectrum. The source of illumination for the secondary cameras can be displaced vertically and laterally from each of the secondary cameras but positioned in the same substantially vertical plane as each of the secondary cameras. Placement of the secondary camera illumination relative to each secondary camera is such that the dots will move in the field of view of each secondary camera to illuminate different pixels depending on the road geometry, as explained below.

The four linear cameras can be timed to obtain images as a function of the travel distance of the vehicle on the road, using a processor or other control component. In a particular implementation, an odometer or other distance-measuring device can be provided, and coupled to the processor or other control component, which triggers the shutters of the cameras to simultaneously obtain an image for every, for example, one inch of travel of the vehicle, for example. Each image from the primary cameras thus can consist of a line of pixels which images the road from the center of the vehicle, approximately the lane center, to a point perhaps 20 feet to each side of the vehicle, depending on the camera field of view, thus providing a continuous image of the road and portions adjacent to the road. Simultaneously, the secondary cameras monitor the shift in spots projected onto the landscape caused by the landscape topology and are able to determine the height topology of the road and its vicinity. This imaging system is coupled to a GPS/INS system, or other position or location determining system for the vehicle whether on-board or separate and apart from the vehicle, that maintains a record of the location and orientation of the cameras and the combination thus provides the information, after storage in one or more appropriate storage components on-board and/or separate and apart from the vehicle, for the off-line or subsequent creation of digital maps which can be used in conjunction with a collision avoidance system and/or for other purposes.

An alternate implementation can be done with two rather than four cameras. In this case, the secondary cameras are eliminated and the array of dots can be projected onto the field of view of the primary cameras. The array of dots also can be at a particular wavelength that is in the visible portion of the spectrum but brighter than the general illumination used for the primary cameras at that frequency. Further, the general illumination can be in the form of a slit of laser creating light in the green or other appropriate wavelength and the dots can be created by an array of lasers, each element of the array producing a dot of light which can be at a different wavelength than the primary illumination. Both illumination sources are projected onto the field of view of each primary camera. The dots can be separated from the resulting images by filters, if desired.

Among other features, information is obtained as to the location of walls, signs, trees, poles and other objects which are on or within approximately 20 feet, for example, of the lane centerline. This distance can be increased or decreased based on the angular field of view designed into the cameras and lens system.

An additional auxiliary camera system pointing forward with a field of view encompassing the area forward and to the side of the vehicle center can simultaneously obtain images, simultaneous to the cameras described above, which later permits the identification of signs and other objects which require a forward view for identification. Thus, the precise location of a sign, for example, can be determined by the linear camera system and the text contents of the sign as well as its shape in a plane perpendicular to the road can be accurately obtained by the auxiliary camera system for use in, e.g., map generation.

This method for creating map data for use on a vehicle in accordance with the invention also includes forming a database including data about lanes on which a vehicle can travel including the locations of a boundary or edges of travel lanes, lane markers and/or other relevant information. Descriptions of all objects on and/or in the vicinity of the road can also be incorporated into the map database.

An alternate method of obtaining data of the roadway and adjacent area comprises substituting a scanning laser radar having a faceted mirror which produces a scan of, for example, ninety degrees at the rate of 500 scans per second, for example, with each scan yielding 4000 pixels of data, for example, with each pixel providing both an image pixel and, through time of flight and/or by phase measurements, the distance to each reflective point in the field of view.

Other improvements will be obvious to those skilled in the art upon reading this specification. The above features are meant to be illustrative and not definitive.

Preferred embodiments of the inventions are shown in the drawings and described in the detailed description below. Unless specifically noted, it is applicant's intention that the words and phrases in the specification and claims be given the ordinary and accustomed meaning to those of ordinary skill in the applicable art(s). If applicant intends any other meaning, they will specifically state they are applying a special meaning to a word or phrase. In this regard, the words velocity and acceleration will be taken to be vectors unless stated otherwise. Speed, on the other hand, will be treated as a scalar. Thus, velocity will imply both speed and direction.

Likewise, applicant's use of the word “function” in the detailed description is not intended to indicate that he seeks to invoke the special provisions of 35 U.S.C. §112, paragraph 6 to define his invention. To the contrary, if applicant wishes to invoke the provision of 35 U.S.C. §112, paragraph 6, to define his inventions, he will specifically set forth in the claims the phrases “means for” or “step for” and a function, without also reciting in that phrase any structure, material or act in support of the function. Moreover, even if applicant invokes the provisions of 35 U.S.C. §112, paragraph 6, to define his inventions, it is applicant's intention that his inventions not be limited to the specific structure, material or acts that are described in preferred embodiments. Rather, if applicant claims his inventions by specifically invoking the provisions of 35 U.S.C. §112, paragraph 6, it is nonetheless his intention to cover and include any and all structures, materials or acts that perform the claimed function, along with any and all known or later developed equivalent structures, materials or acts for performing the claimed function.

For example, the present inventions often make use of GPS satellite location technology, including the use of RTK DGPS. The inventions described herein are not limited to the specific GPS or DGPS devices or techniques disclosed in preferred embodiments, but rather, are intended to be used with any and all such applicable satellite and/or infrastructure location devices, systems and methods, as long as such devices, systems and methods generate input signals that can be analyzed by a computer to accurately quantify vehicle location and kinematic motion parameters in real time. Thus, the GPS, RTK DGPS and other devices and methods shown and referenced generally throughout this disclosure, unless specifically noted, are intended to represent any and all devices appropriate to determine such location and kinematic motion parameters.

Further, there are disclosed several processors or controllers, that perform various control operations. The specific form of processor is not important to the invention. In its preferred form, the computing and analysis operations are divided into several cooperating computers or microprocessors. However, with appropriate programming well known to those of ordinary skill in the art, the inventions can be implemented using a single, higher power computer. Thus, it is not applicant's intention to limit his invention to any particular form or location of processor or computer. For example, it is contemplated that in some cases, the processor may reside on a network connected to the vehicle such as one connected to the Internet.

Further examples exist throughout the disclosure, and it is not applicant's intention to exclude from the scope of his invention the use of structures, materials, or acts that are not expressly identified in the specification, but nonetheless are capable of performing a claimed function.

The above and other objects and advantages of the present invention are achieved by preferred embodiments that are summarized and described below.

### BRIEF DESCRIPTION OF THE DRAWINGS

The various hardware and software elements used to carry out the invention described herein are illustrated in the form of system diagrams, block diagrams, flow charts, and depictions of neural network algorithms and structures. Preferred embodiments are illustrated in the following figures:

FIG. 1 is an illustration of front, side and top views of a mapping vehicle showing camera locations according to the teachings of this invention; and

FIG. 2 is an illustration of the mapping vehicle of FIG. 1 illustrating various parameters that are used in the mathematical analysis of the Appendix.

### DETAILED DESCRIPTION OF THE INVENTION

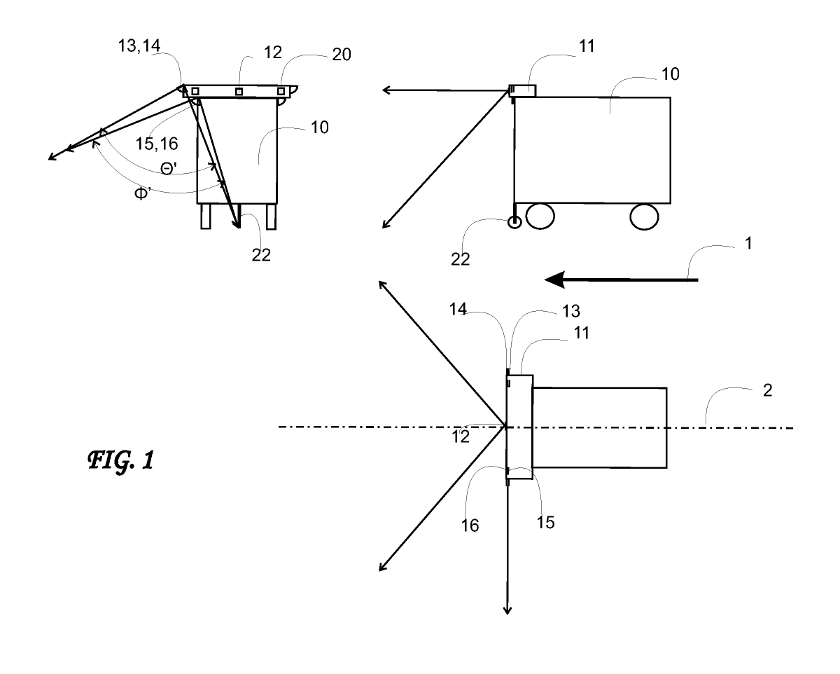

Data about roads can be acquired by a mapping vehicle which can have a variety of structures and have a variety of cameras mounted at various locations typically on and/or near a roof of the vehicle. A functional diagram of such a mapping vehicle 10 is illustrated in FIG. 1 with the following references:

1—motion direction;

2—center or central line of the road or lane of the road;

11—camera and global navigation satellite system (GNSS) module;

12—forward looking camera system;

13—illuminator for primary road imaging camera;

14—illuminator for structured light camera for topology determination;

15—primary road imaging camera;

16—structured light camera for topology determination;

20—GPS, DGPS, INS and processor(s) assembly;

22—odometer sensor.

φ′—Cameras field of view

⊖′—Illuminators field of view

The camera and GNSS module 11 is typically a rigid structure that contains, within a housing, all of the data acquisition parts of the system except the odometer sensor 22, e.g., one or more of the forward-looking camera systems 12, one or more of the primary road imaging cameras 15 and one or more of the structured light cameras 16. The construction is sufficiently rigid so as to minimize, and possibly eliminate, relative motion between the cameras 12, 15, 16, illuminators 13, 14 and GNSS components 20. The module 11, or the housing thereof, can be mounted to any suitable vehicle such as a van and should be mounted solidly or fixed to the vehicle structure, e.g., the frame of the vehicle, with a lateral axis of the module 11 carefully adjusted so as to be operatively parallel to the road being mapped and perpendicular to a longitudinal axis of the vehicle. Module 11 can be constructed in a factory and/or laboratory where the relative locations of the illuminators and cameras can be accurately fixed and established. It is important that once the various elements of the system have been properly mounted into and/or onto module 11, no further relative motion of the components are permitted. The relative locations and angular positions in 6 dimensions of each of the components can be set and recorded when the module 11 is assembled according to the system specifications. The accuracy of the mapping process, and thus the final accuracy of the maps, depends on the locations and angular positions of the cameras, illuminators and GNSS modules 11.

Forward-looking camera system 12 operatively obtains views of the road and surrounding area which are unobtainable and/or difficult to obtain from side (lateral) and downward looking cameras 15 and 16. This camera system 12 is not primarily used for the accurate location determination of objects but is primarily used to aid in their recognition. For example, a stop sign can be located accurately including a determination of its height, as discussed below, by the lateral viewing cameras 15, 16, but the shape and text on the sign cannot be determined by the lateral viewing cameras 15, 16. On the other hand, both the shape and other information which can only be determined from a frontal view of the sign can be determined by the forward-looking camera system 12 permitting the sign to be identified for inclusion in the map database. The camera system 12 can comprise a single camera or multiple cameras. Camera system 12 is forward-looking because it images an area in front of the vehicle 10 in the direction of motion 1.

Illuminator 13 operatively illuminates the field of view of the primary road imaging camera 15. Although it is illustrated displaced from camera 15, this is for mounting convenience only. As long as illuminator 13 resides in the same vertical plane as the camera 15 and as long as it is relatively near to the camera but not where its illumination will be obstructed by the camera and is itself not in the camera field of view, its exact location is not important. The function of illuminator 13 is to provide illumination to the line of pixels which is viewed and imaged by camera 15. To conserve energy and provide appropriate illumination, it should be bright and focused so that in provides a slit of light that illuminates the pixels in the field of view of camera 15. Illuminator 13 should be accurately aligned with camera 15 and thus can best be done, e.g., in a laboratory where the module 11 is assembled. A device having the desired properties is available from at least one commercial entity. Illuminator 13 can preferably provide illumination in the visible part of the electromagnetic spectrum but other frequency ranges can be used. Illuminator 13 can also be created from a laser source with appropriate lensing.

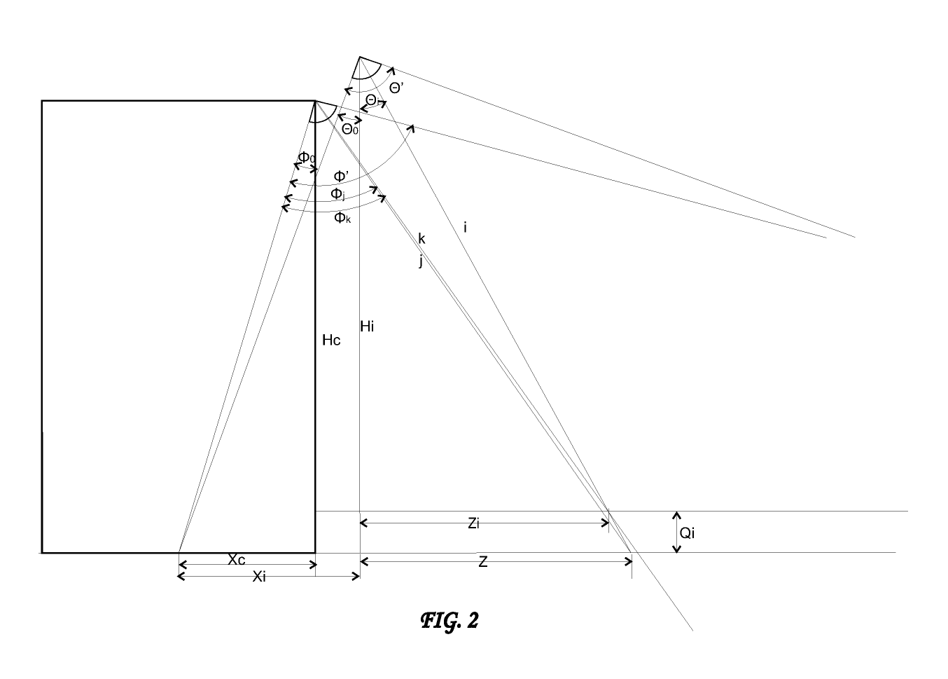

Camera 15 is a linear camera containing, for example, a line of from about 2000 to about 10000 pixels with about 4000 pixels as a typical number. Camera 15 can image through a cylindrical or other suitable lens which can encompass a field of view of about 90 degrees, for example, or some other appropriate amount. Camera 15 is preferably mounted so that its field of view lies in a substantially vertical plane and stretches from the vehicle center line 2 at the road surface to an appropriate angle such as about 65 degrees from the vertical as illustrated by φ′ as approximately ninety degrees in total in FIGS. 1 and 2. Camera 15 can provide a field of view for a level road and adjacent area of about 20 or more feet. This view area can be adjusted by the camera mounting parameters as detailed in the analysis in the Appendix. An appropriate camera for the purposes herein is available from Fairchild Imaging, Milpitas Calif., as CCD 191 which is a 6000 element linear image sensor.

The illuminator 14 is provided to illuminate the field of view of the secondary road imaging camera 16. It is illustrated displaced from camera 16 and this relative displacement is important to the functioning of this subsystem. The illuminator 14 should also reside in the same vertical plane as the camera 16. The function of illuminator 14 is to provide illumination in the form of spaced dots to the line of pixels which is viewed and imaged by camera 16. To conserve energy and provide appropriate illumination it should be bright and focused so that in provides a slit of light in the form of dots that illuminates the pixels in the field of view of camera 16. It is preferably accurately aligned with camera 16 and thus can best be done in a laboratory where the module 11 is assembled. A device having the desired properties can be constructed from individual lasers which are arranged in an arc and appropriately spaced. Each such laser can be individually aligned during manufacture of the array. The illuminator 14 can provide illumination in the visible part of the electromagnetic spectrum or, preferably, in the infrared portion of the spectrum and most preferably in the eye safe portion of the spectrum which would permit the use more powerful light sources if in the eye-safe portion of the spectrum (wavelength >1.4 microns). By using different portions of the spectrum, the illumination from the two illuminators will not interfere with each other and can be separated in the resulting images. It is important that the dots as seen by camera 16 and not be washed out by the illumination from illuminator 14. By using the eye safe portion of the electromagnetic spectrum, the brightness of the dots can be substantially increased by a factor of 10 or 100 and not pose a danger to humans that might be inadvertently illuminated during the mapping process. The illuminator 14 can produce from 100 to 5000 discernible dots separated by un-illuminated areas and distributed more or less evenly over the field of illumination. The field of illumination for illuminator 14 is illustrated as ⊖′ in FIGS. 1 and 2.

The camera 16 is also a linear camera similar to camera 15 containing, for example, a line of 2000-10000 pixels with 4000 pixels as a typical number. The camera 16 can image through a cylindrical or other suitable lens which can encompass a field of view of 90 degrees, for example, or some other appropriate amount. The camera 16 is preferably mounted so that its field of view lies in a substantially vertical plane and stretches from the vehicle center line 2 at the road surface to an appropriate angle such as about 65 degrees from the vertical as illustrated by φ′ in FIGS. 1 and 2. This should provide a field of view for a level road and adjacent area of about 20 feet and is the same field of view as provided for camera 15. This view area can be adjusted by the camera mounting parameters as detailed in the analysis in the Appendix. If IR illumination is used, then camera 15 can be provided with an IR blocking filter and camera 16 provided with a filter that blocks light from the visual portion of the spectrum. An appropriate camera for the purposes herein is the same as referenced above from Fairchild Imaging.

Dot illumination, as used in a preferred implementation herein, is a form of structured light and other structured light arrangements will now be obvious to those skilled in the art. The vertical extent of the dots can be varied, for example, in order to permit easy location of the reflected dot images in the camera, that is, identification of the corresponding dot from the illuminator. If cameras having a two dimensional field of view are used, then the options for the use of structured light become enormous. As a simple example, if the cameras that are used have two rows of pixels, then the dots can be arranged so that there is a pattern variation between the two rows of dots such that it becomes easy to identify each dot in the resulting image. Even if only a single row of pixels are used, it is possible to vary the dot illumination pattern over time using, for example, a processor, so as again to assist in dot identification and thus to simplify post processing of the data.

A basic teaching of this invention involving structured light is to transmit the light pattern from a location which is not co-located with the camera and thus cause the location of the dots or other shapes in the image to vary with distance from the camera or other imager. This provides a measurement of the third dimension in much the same manner as stereo imaging does but with a much simpler calculation. Basically, all that is necessary is to count pixels in the linear camera implementation and determine the amount that a dot has moved from its expected location if the illuminated area were horizontal and in the plane of the road. That movement is related to the elevation of the ground where the dot illumination was reflected to the camera as mathematically disclosed in the Appendix.

Another implementation of structured light is to use a two dimensional imager which, for example, can have 4000 pixels in both the vertical and longitudinal directions. A cylindrical lens can still be used but the images can only be acquired much less frequently to obtain greater longitudinal accuracy. Other geometric lenses can be used to alter the field of view. Again, a key teaching of this invention is to use structured light for acquiring photogrammatic data used for the generation of road maps in place of alternate stereo methods.

As an example, consider the case the following parameter values set forth in FIG. 2:

| | |
|---|---|
| Vehicle width (feet) | 6.00 |
| Camera height (feet) - Hc | 7.00 |
| Camera from vehicle center (feet) - Xc | 3.00 |
| Spot Illuminator height (feet) - Hi | 8.00 |
| Illuminator from vehicle center (feet) - Xi | 4.00 |
| Camera View angle (degrees) - Φ′ | 90.00 |
| illuminator View angle (degrees) - Θ′ | 90.00 |
| # pixels in Camera view - Nc | 4000.00 |
| # spots + spot blanks in illuminator view - Ni | 4000.00 |

Using the equations developed in the Appendix, considering the design where the dot illuminator projects about 2000 dots of structured light spread over about 4000 pixels, then for the case where the illuminator pixel number 2000 reflected from the ground and illuminated pixel 2208 in the camera, this would only happen if the ground was raised one foot and the reflection point was about 6.33 feet from the vehicle center. At that point, 1 centimeter of additional height would cause the dot to displace about 13 pixels in the image providing significant resolution. Additional calculations indicate that for this case, the camera would have been rotated initially by about 23 degrees and on a horizontal landscape, its field of view would extend to about 19 feet from the vehicle center. Even at the extent of the camera range, about 19 feet, one centimeter of elevation translates to almost 6 pixels of dot displacement in the image. Note that in order to get 4000 dots in the image, only 2000 dots need to be illuminated as the space between the illuminated spots can also be counted as dots.

In addition to providing an easy method for mapping the topology of the road and its vicinity, a very clear continuous image is provided of the roadway itself making it easy to locate and map lane markers, road edges and shoulder edges either by hand or automatically with simple pattern recognition software. The image will easily show the location and height of signs, walls, curbs, poles and trees that are within the field of view. Again the automating of these calculations is straightforward. When the identity of an object is not obvious from a lateral image, the forward-looking camera can be used. The forward-looking camera system 12 however does not need to be relied upon for the location of objects in the environment and thus the mounting requirements and camera specification is substantially simplified.

The shutter of the cameras can be controlled by the odometer system 22, which may be coupled to one another through a controller or processor. This controller or processor (not shown) receives data about vehicle speed from the odometer sensor 22, i.e., in the form of signals sent through wires or wirelessly, and based thereon, triggers image obtaining by the camera systems 12, 15 and 16, e.g., through an algorithm or other appropriate software program or functionality. The cameras specified above are capable of acquiring images at greater than about 500 frames per second. Thus, with the mapping vehicle traveling at about 30 MPH, or about 500 inches per second, the odometer can cause the cameras to trigger for every inch of vehicle travel. If the primary and secondary cameras are spaced one inch apart, then during post-processing, the image from the secondary camera need only be moved one frame to exactly overlay with the image from the primary camera. If, on the other hand, the secondary cameras are not used and the dots illuminated in the field of view of the primary cameras, then only half as much data need be obtained and stored. A certain amount of image compression can be achieved on the mapping vehicle probably resulting in significantly less than a byte per pixel for image storage. Assuming however that 1 byte per pixel is necessary, a mile of road translates to about 250 MB of data per side to be transmitted to the processing location. A 1 terabyte hard drive could thus hold about 2000 miles of data from both sides of the vehicle with minimal compression. With sophisticated compression, this could probably be increased by a factor of 10. If images from the forward-looking camera 12 are included, the data storage requirements could double but still remain within reasonable bounds. Adding information from the GNSS system similarly will increase the data storage requirements which may be significant depending of the quantity of such data and how it is compressed. In any event, the storage requirements for a day of mapping are not significant.

The GPS, INS and odometer sensors register positioning and attitude information. For 3D precise positioning, two Ashtech GPS dual frequency receivers can be used. The first receiver is used as a base receiver and it is placed on a stationary reference point on the ground for the generation of RTK differential corrections. The other one is called the rover receiver, and it is placed on the vehicle. For this design, two such receivers are contemplated. The INS Litton LN-200 sensor registers both position and attitude. The odometer measures the distance traveled and can be used to trigger the camera shutters.

There are several prior art mapping vans that have been developed, as listed in the table below, similar to the On-sight® system developed by Ohio University. These include, for example, ARAN, CDSS, DAVIDE, GEOVAN, GPSVan, GPSVision, KiSS, TruckMAP and VISAT. All are considerably more complicated than the one disclosed herein and none are capable of centimeter level accuracy as is the case of the mapping vehicle of this invention.

Current MMS system on the market

| | System | | |
|---|---|---|---|
| No. | name | Delivered by | Components |
| 1 | ARAN | Roadware Corp. Paris, | GPS, INS, CCD, |
| | | CND | ultrasonic sensor |
| 2 | CDSS | Rheinisch-Westfalishe | GPS, odometer, CCD, |
| | | Technische Hochschule | Video |
| | | Achen (FRG) | |
| 3 | DAVIDE | SEPA (Torino, I) ELDA | GPS, INS, CCD, |
| | | (Treviso, I) | video |
| 4 | GEOVAN | Geospan Corp. | GPS, INS, CCD |
| | | (Minneapolis, USA) | |
| 5 | GPSVan | Ohio State University | GPS, INS, odometer, |
| | | (Columbus, USA) | CCD, video |
| 6 | GPSVision | Lambda Tech Int. me. | GPS, INS, odometer, |
| | | (Waukesha, USA) | CCD |
| 7 | KiSS | Universitat des | GPS, INS, odometer, |
| | | Bundeswerh | CCD, Video |
| | | München (PRG) | |
| 8 | TruckMAP | John E. Chance | GPS, odometer, laser |
| | | Associates Inc. | range finder, video |
| | | (Lafayette, USA) | |
| 9 | On-Sight | Transmap Corporation | GPS, INS, odometer, |
| | | (Columbus, USA) | CCD |
| 10 | VISAT | University of Calgary | GPS, INS, odometer, |
| | | (CND), GEOFTT Inc. | CCD, video |
| | | (Laval, CND) | |

The technical requirements of the MMS and road infrastructure features are set forth in the provisional application incorporated by reference herein.

The Mobile mapping system (MMS) implements a principle based on a geo-referencing photogrammetric model making use of data about the orientation and positioning of a mapping equipment carrier vehicle received from GPS satellites, integrated with IMU (Inertial Navigation System—INS) and an odometer (a meter of traveled distance and the traveling car speed).

Accurate positioning and the identification of transportation and other infrastructure (e.g., a traffic sign, the curb line) can be an immense task when the prior art equipment and techniques are used requiring the efficient collection of vast quantities of data as discussed in the provisional patent application disclosed above. The new technologies presented in this disclosure greatly improve data collection and processing. Any object that is in the field of view of the forward-looking camera system 12 can be identified either by an operator during post-processing or through the use of pattern recognition software such as neural networks. Then, the object can be precisely located by the line cameras that look down and to the side capturing the objects and topology that reside in the environment in the field of view of the cameras. In the example given here, this stretches out to approximately 20 feet on either side of the lane and can be significantly increased through the choice of camera, lens and mounting parameters. This field of view can be increased to 30 feet, for example, by raising the height of the cameras and illuminators to 9 feet and 10 feet respectively. This reduces the elevation resolution to about 3 pixels per centimeter at 30 feet.

GPS provides accurate position data but at a low data rate (1 Hz) and the requirement of reception from at least four satellites, thus the use of GPS alone is limited. In contrast, INS provides a high rate position (X, Y, Z coordinates) and attitude (Pitch, roll and yaw) information (100 Hz), but its sensor errors tend to grow with time. By integrating GPS and INS, the accurate GPS positioning is used to update the INS, through the use of a Kalman filter, and the INS then produces the high rate, accurate position and attitude data, even when the GPS signals are lost.

The system can be used to collect digital images along highways, state roads, residential streets and/or railroads while traveling at least at about 30 MPH or faster approaching highway speed limits depending on equipment capabilities and desired number of frames per unit of distance traveled. If the width of a pixel is set by the lens such that a composite image results with no gaps, then even thin sign posts will not be missed.

Every object or feature in the primary camera view can be tagged with its location as determined by the GPS/INS system and connected with the objects identified in the images from the forward-looking camera system 12 thereby providing the map database with the location and identity of all objects on or in the vicinity of the roadway. The position of visible physical features, such as curbs, lines, traffic signs, manholes, pedestals and building locations can be readily determined by relatively simple software. Thus, this positioning system can create accurate maps of the street network for GIS-based map applications mostly automatically through the use of simple software. There is no need to stereo match pairs of images to determine distances as in prior art systems.

The linear images are recorded as acquired, along with the dot images from the secondary camera system if used, as intensity variations on the primary camera images. Each linear row of pixels is also tagged or otherwise correlated or related with the output from the INS. The INS output can later be used in a first post-processing step to adjust the images to place them in a vertical plane which can be referenced to the location of the road surface immediately beneath the cameras or to some other appropriate coordinate system reference. Thus, if the vehicle experiences a momentary shift in location or angular orientation by a bump in the road, for example, the resulting effect on the image can be eliminated. The corrected continuous composite image from the primary cameras coupled with the elevations calculated from the pixel shift of the dots in the secondary camera images can later be converted in a second post-processing step to GIS or other appropriate format in the construction of the map database. This second post-processing step is beyond the scope of this disclosure and known to those skilled in the art and described in the above-referenced provisional patent application.

The road centerline 2 can be used as the road reference for the images in the first post-processing step (see FIG. 1). For this step, the location of the road centerline 2, lane marker and/or other selected road reference can be determined from the INS after it has been sufficiently smoothed to remove short term fluctuations from the data. Once the location and orientation of this road reference has been determined, then the images can be adjusted so that they lie in a vertical plane substantially perpendicular to the road reference line.

The geo-referenced digital image data and the position and attribute data of the roadway features can be stored in a simple format which is readily transportable to standard GIS systems by those skilled in the art.

Once the data is processed by one or more processors conducting the steps described above, it can be loaded therefrom, e.g., in the form of files or other known form, into the target GIS, where the data is easily displayed in a map format, analyzed and/or manipulated utilizing GIS database query functions. A typical client software program or application executed by a processor can use this data to accurately position traffic signs and other features and road objects, develop base maps or view image data directly from an operator's personal workstation in the vehicle as one drives down the road.

As an accuracy verification, once the data has been processed in the first post-processing step discussed above, it can be readily used with simple software on a vehicle to position a laser pointer to illuminate the road and lane edges to provide a quick visual verification of the accuracy of the data. The position of the laser spot can also be captured using simple cameras permitting a record to be made of the data accuracy for later review and certification.

The integration of GPS/INS can be performed at different levels and using known methods. Some of them benefit from the Kalman filter method, which is recognized as an industry standard. The GPS is preferably corrected using known RTK DGPS technology, as briefly discussed above, wherein fixed GPS receivers are periodically located at positions, such as every 25 miles along the roadway, which transmit GPS corrections to the mapping vehicle. These stationary GPS receivers can be relocated as the mapping process proceeds. In one implementation, the stationary RTK GPS receivers are prepositioned 12 hours in advance of the mapping to allow the receivers to determine their accurate locations. Each of these RTK receivers periodically, such as once every 5 minutes or other appropriate time, transmits the GPS corrections to the mapping vehicle.

The GPS/INS state vector can include the six positions and angles of the module as well as their derivatives and associated bias and/or drifts, as is known in the art. The Kalman filter consists of a known sophisticated prediction and an update method that uses the DGPS corrected GPS positions and maintains the INS in a high accuracy state.

The inertial navigation system can be platform-based and when combined with the differential corrections (DGPS), the coordinates of the INS/GPS module can be determined within the 2 centimeter (one sigma) accuracy desired, provided the continuous GPS signal is received from 5 or more satellites.

An inertial navigation system of choice can be one of several commercially available systems such as, but not limited to, the Applanix Version 5 or later of its

Position and Orientation System for Land Vehicles (POS LV). The POS LV uses Kalman filtering, GPS, GPS azimuth measurement and a Distance Measurement Indicator (DMI), to provide position and orientation data that have a high bandwidth, excellent short-term accuracy and minimum long-term errors.

The system provides dynamically accurate, high-rate measurements of the full kinematics state of the host vehicle. POS LV can also provide motion compensation information to other sensor systems onboard the host vehicle.

Its principal features are:
1. Integrated DMI/GPS/inertial sensors
2. Robust and precise position and orientation measurements
3. True heading accuracy to about 0.02° independent of latitude and dynamics
4. Blended Kinematics Ambiguity Resolution (KAR) position data to about 2 cm accuracy
5. Complete navigation and attitude solution
6. Continuity of all data and data accuracy during GPS dropouts
7. No motion artifacts, even under the most severe conditions
8. No gyro spin-up time
9. Compact and reliable
10. Digital and Ethernet interfaces
11. Self-calibrating for rapid deployment
12. 200 Hz real-time true data rate
13. Less than about 5 msec data latency
14. Fast in-motion alignment/initialization—no need for static initialization
15. Compact Inertial Measure Unit (IMU or INS) in protective housing
16. Can be mounted internally or externally on the host vehicle
17. Can be mounted directly on any sensor
18. High-reliability fiber-optic technology
19. Built-in data logging on PC-card disk drive for post-processing
20. 200 Hz DMI
21. 1 Hz GPS
22. 200 Hz inertial
23. POSPac post-processing software for maximum accuracy
24. Fast post-processing of data in the field (on laptop-PC)
25. Multiple, reconfigurable interfaces for the precise time-alignment of POS data with road sensors
26. Pitch/roll accuracy: <0.01° real-time* (DGPS), <0.005° post-processed* a No GPS outages
27. True heading accuracy: <0.04° real-time* (DGPS), <0.02° post-processed* a No

GPS outages

Other detail specifications and applications can be obtained from Applanix however some of the characteristics are:

The Applanix core POS/LV has five main components:

1. POS Inertial Measurement Unit—IMU the system's primary sensor. Contains three fiber-optic gyros, three silicon accelerometers, and data processing and conversion electronics.
2. POS Computer System (PCS), a rugged computer system configured for 19″ rack mounting. Contains the core POS processor, IMU and

DMI interface electronics, two GPS receivers and a removable PC-card disk drive for post-processing of POS data.
3. Distance Measurement Indicator (DMI), a rugged sensor that mounts directly to one of the host vehicle's rear wheels. The universal mount fits most production vehicles. Provides host vehicle distance traveled aiding data. Contains a metal disc rotary encoder.
4. Primary GPS Receiver Antenna, an L1/L2 (dual frequency) antenna. Provides information for system timing, position and velocity aiding.
5. Secondary GPS Receiver Antenna, an L1 only (single frequency) antenna. Provides GPS raw observable data for use with the GPS Azimuth Measurement Subsystem (GAMS).
   All listed integrated GPS/INS systems form and output the following numbers:
1. Positioning data along axes X, Y, Z with the error 2 cm on each axis;
2. Roll and pitch angles with the accuracy at least 0.05°;
3. Value of the true heading with the accuracy at least 0.07°/hr;
4. Relative traveling speed;
5. Angular speeds and accelerations along axes;
6. Time and distance marks.
7. All output data have time and distance marks.

The accuracy of the integrated platforms for the GPS/INS application is sufficient to provide the desired accuracy 2 cm (one sigma).

### Appendix

With reference to in particular to FIG. 2, let:
i=the pixel number for a projected dot from the illuminator
j=the camera pixel number for dot i reflected off of a horizontal road
Qi=the height of the actual road illuminated by pixel i
k=the camera pixel number for dot I reflected off of the actual road
⊖′=Total illuminator angle
⊖0=rotation angle of illuminator to illuminate road at vehicle center
⊖i=Angle from vertical to illuminator pixel i
φ′=Total camera angle
φ0=rotation angle of camera to see illuminated road at vehicle center
φj=Angle from vertical to camera pixel j which sees illuminated pixel i from horizontal road
φk=Angle from vertical to camera pixel k which sees illuminated pixel i from actual road
Hi=Height of illuminator
Hc=Height of camera
Ni=Number of dots plus spaces in illuminator—there can be at least one space for every dot.
Nc=Number of pixels in camera field of view.
Z=Horizontal distance from illuminator vertical to illuminated point i on horizontal road
Xi=Horizontal distance from illuminator vertical to vehicle center
Xc=Horizontal distance from camera vertical to vehicle center
Zi=Horizontal road location of illuminated pixel i on actual road
Input illuminator pixel i
Input camera illuminated pixel k
Find location of i on horizontal road from illuminator vertical—Z=Hi*(tan(i*⊖′/Ni−⊖0))
Find illuminator angle for pixel i—⊖i=⊖0+a tan(Z/Hi)
Find camera angle for pixel j—φj=φ0+a tan((Z+Xi−Xc)/Hc)
Find camera pixel j illuminated by dot i on horizontal road—j=φj/φ′*Nc
Pixel shift in camera=k−j
Find Camera angle for pixel k—φk=k*φ′/Nc
Road height Qi=(Xi−Xc+Hi*tan(⊖i−⊖0)−Hc*tan(φj−φ0))/(tan(⊖i−⊖0)−tan(φj−φ0))
Horizontal road location of illuminated pixel i on actual road—Zi=(Hi−Qi)*(tan(⊖i−⊖0))

Although several preferred embodiments are illustrated and described above, there are possible combinations using other geometries, sensors, materials and different dimensions for the components that perform the same functions. The inventions disclosed herein are not limited to the above embodiments and should be determined by the following claims. There are also numerous additional applications in addition to those described above. Many changes, modifications, variations and other uses and applications of the subject invention will become apparent to those skilled in the art after considering this specification and the accompanying drawings which disclose preferred embodiments thereof. All such changes, modifications, variations and other uses and applications which do not depart from the spirit and scope of the invention are deemed to be covered by the invention which is limited only by the following claims.

1. A vehicle for obtaining data for road mapping, comprising:
an image obtaining module fixed to the vehicle, said image obtaining module including:
a forward-looking camera system positioned to obtain images, each of an area in front of the vehicle, the images including at least part of the road lane and adjacent area;
a side and downward-looking camera system mounted on the vehicle and positioned to obtain images, said side and downward-looking camera system being positioned relative to the vehicle such that each image is from an area extending from a point on the road lane outward in a direction away from the vehicle and which includes the same part of the road lane and adjacent area as one or more of the images obtained by said forward-looking camera system;
a source of structured light at a location apart from said side and downward-looking camera system and illuminating ground in a field of view of said side and downward-looking camera system; and
at least one global navigation satellite system (GNSS) module containing a GPS receiver and an inertial navigation system, said at least one GNSS module being coupled to said image obtaining module,
whereby images obtained by said image obtaining module are assocated with a position of the vehicle when the images are obtained by said image obtaining module in order to enable creation of a map of a road imaged by said image obtaining system.

2. The vehicle of claim 1, wherein said source of structured light is configured to generate spots of light.

3. The vehicle of claim 1, wherein said source of structured light is configured to generate light in an infrared portion of the electromagnetic spectrum.

4. The vehicle of claim 1, further comprising a frame, said module being mounted to said frame of the vehicle such that, during use of said forward-looking and side and downward-looking camera systems for mapping the road, a lateral axis of said module is parallel to the road being mapped and perpendicular to a longitudinal axis of the vehicle.

5. The vehicle of claim 1, wherein said forward-looking camera system comprises at least one linear camera.

6. The vehicle of claim 1, wherein said source of structured light comprises an illuminator, said illuminator being arranged on the vehicle in a fixed position relative to said side and downward-looking camera system, displaced from said side and downward-looking camera system camera and residing in a common vertical plane as said side and downward-looking camera system.

7. The vehicle of claim 1, wherein said side and downward looking camera system comprises a linear camera mounted so that its field of view, during operation, lies in a substantially vertical plane and stretches from a vehicle center line at a surface of the road surface on which the vehicle is travelling to an appropriate angle of about 65 degrees from the vertical.

8. The vehicle of claim 1, wherein said side and downward-looking camera system comprises a primary road imaging camera and a structured light camera for topology determination, and wherein said source of structured light comprises a first illumination source associated with said primary road imaging camera and a second illumination source associated with said structured light camera which is separated from said first illumination source, said second illumination source being displaced from said structured light camera and residing in a common plane as said structured light camera, said second illumination source being configured to operatively provide illumination in a form of spaced dots to a line of pixels which is viewed and imaged by said structured light camera.

9. The vehicle of claim 1, wherein said side and downward-looking camera system comprises a primary road imaging camera and a structured light camera for topology determination, said primary road imaging camera and said structured light camera each being a linear camera.

10. The vehicle of claim 1, wherein said side and downward-looking camera system is situated adjacent said forward-looking camera system.

11. A method for obtaining data for road mapping, comprising:
driving a vehicle along a road, the vehicle including an image obtaining module mounted thereto, the image obtaining module including:
a forward-looking camera system positioned to obtain images from an area in front of the vehicle in a substantially vertical plane, the images including at least part of the road lane and adjacent area;
a side and downward-looking camera system mounted on the vehicle and positioned to obtain images in a substantially vertical plane of substantially the same portion of the road lane and adjacent area as the forward-looking camera system;
a source of structured light emanating from a location apart from the side and downward-looking camera system and illuminating ground in a field of view of the side and downward-looking camera system;
periodically obtaining images from the forward-looking camera system simultaneous with images from the side and downward-looking camera system;
determining a position of the vehicle along the road when images are obtained; and
associating the obtained images at each instance with the determined position of the vehicle;
whereby a map of the road can be derived based on the association of the obtained images with the determined position of the vehicle.

12. The method of claim 11, wherein the step of determining the position of the vehicle comprises arranging at least one GNSS module containing a GPS receiver and an inertial navigation system on the vehicle and which provide positional output relating to the vehicle.

13. The method of claim 11, further comprising generating spots of light from the source of structured light.

14. The method of claim 11, further comprising generating light in an infrared portion of the electromagnetic spectrum from the source of structured light.

15. The method of claim 11, further comprising mounting the module to a frame of the vehicle such that, during use of the forward-looking and side and downward-looking camera systems for mapping the road, a lateral axis of the module is parallel to the road being mapped and perpendicular to a longitudinal axis of the vehicle.

16. The method of claim 11, wherein the source of structured light comprises an illuminator, further comprising arranging the illuminator in a fixed position relative to the side and downward-looking camera system, displaced from the side and downward-looking camera system camera and residing in a common vertical plane as the side and downward-looking camera system.

17. The method of claim 11, wherein the side and downward looking camera system comprises a linear camera mounted so that its field of view, during operation, lies in a substantially vertical plane and stretches from a vehicle center line at a surface of the road surface on which the vehicle is travelling to an appropriate angle of about 65 degrees from the vertical.

18. The method of claim 11, wherein the side and downward-looking camera system comprises a primary road imaging camera and a structured light camera for topology determination, further comprising:
associating a first illumination source with the primary road imaging camera;
associating a second illumination source with the structured light camera which is separated from the first illumination source;
arranging the second illumination source displaced from the structured light camera and residing in a common plane as the structured light camera; and
configuring the second illumination source to operatively provide illumination in a form of spaced dots to a line of pixels which is viewed and imaged by the structured light camera.

19. The method of claim 11, wherein the side and downward-looking camera system comprises a primary road imaging camera and a structured light camera for topology determination, the primary road imaging camera and the structured light camera each being a linear camera.

20. The method of claim 11, further comprising situating the side and downward-looking camera system adjacent the forward-looking camera system.
